(19) United States
(12) Patent Application Publication
(10) Pub. No.: US 2011/0275750 A1
(43) Pub. Date: Nov. 10, 2011

(54) Complex Ester As Solvent For Printing Inks (III)

(75) Inventors: Peter Bene, Koln (DE); Juergen Baro, Esslingen (DE); Jürgen Röder, Dusseldorf (DE); Stefan Busch, Dusseldorf (DE)

(73) Assignee: COGNIS IP MANAGEMENT GMBH

(21) Appl. No.: 13/144,521

(22) PCT Filed: Dec. 21, 2009
(86) PCT No.: PCT/EP09/09191

§ 371 Date: Jul. 14, 2011

(30) Foreign Application Priority Data
Jan. 15, 2009 (EP) 09000463.1

(51) Int. Cl. C08K 5/11; C11C 3/06; C08K 5/101

(52) U.S. Cl. 524/310; 524/311; 524/317; 554/227; 554/173

(57) ABSTRACT

Solvents for offset printing inks comprising at least one fatty acid ester that is the reaction product of at least one of C₆₋₂₆ fatty acid and at least one polyhydroxy compound selected from the group consisting of polyglycerols, and adducts of 1 to 20 mol of ethylene oxide and/or propylene oxide with polyglycerols.

### FIELD OF THE INVENTION

The invention relates to the use of specific complex esters as solvents for printing inks.

### PRIOR ART

At the present time there are low-odor and low-taste offset printing inks which are based on esters of fatty acids and monohydric alcohols. On account of their relatively low molecular weight, however, these esters have a more or less pronounced tendency toward migration, a phenomenon which in the packaging sector it is desirable to avoid as far as possible, or at least greatly to minimize. The packaging sector here encompasses, as packaging materials, not only cardboard packaging but also polymeric films of various chemical compositions. One specific phenomenon affecting such films is that of swelling, which is significant especially with thin films. This swelling is an irreversible formation of creases and corrugations in the material. EP 886,671 B1 describes esters of C₆₋₂₂ fatty acids and specific polyhydric alcohols (trimethylolpropane, pentaerythritol, dipentaerythritol, sorbitol, and 2-butyl-2-ethyl-1,3-propanediol) as solvents for offset printing inks. DE 10 2007 021 131 A1 and DE 10 2007 021 134 A1 describe specific complex esters as solvents for printing inks.

### DESCRIPTION OF THE INVENTION

There is a continual need for new solvents for offset printing inks. As the skilled person is aware, such solvents have the function of dissolving the resins that are present in the offset printing inks.

The object of the present invention was to provide solvents for offset printing inks.

These solvents ought to be distinguished by minimal inherent viscosity. They ought, furthermore, to exhibit excellent solvency for solid resins that are suitable for offset printing, and more particularly for commercially customary solid offset printing ink resins.

Furthermore, these solvents ought in particular to be suitable for the sector of food packaging, and in this respect ought to be distinguished in particular by low migration potential and odor potential. They ought, furthermore, to be low-swelling.

The objects identified above are achieved superlatively by the use as solvents for offset printing inks of fatty acid esters based on C₆₋₂₆ fatty acids and polyhydroxy compounds selected from the group consisting of polyglycerols and adducts of 1 to 20 mol of ethylene oxide and/or propylene oxide with polyglycerols.

The present invention first provides for the use of fatty acid esters based on C₆₋₂₆ fatty acids and polyhydroxy compounds selected from the group consisting of polyglycerols and adducts of 1 to 20 mol of ethylene oxide and/or propylene oxide with polyglycerols as solvents for offset printing inks.

The expression “adducts of x mol of ethylene oxide and/or propylene oxide with polyglycerols” refers to adducts of x mol of ethylene oxide and/or propylene oxide per mole of polyglycerol.

Fatty acid esters for use in accordance with the invention may be partial esters or full esters. In one preferred embodiment they are full esters, i.e., all of the OH groups of the polyhydric alcohols on which the esters are based are fully esterified.

The fatty acid esters may be used individually or in a mixture with one another.

In one embodiment, the fatty acid esters for use in accordance with the invention have viscosities in the region of 50 mPas and 500 mPas (measured in accordance with DIN 53299; viscosity measurement with rotational viscometer at 23° C.), and preferably in the range from 70 to 150 mPas.

In one embodiment, the fatty acid esters for use in accordance with the invention have acid numbers below 10 mg KOH/g, and more particularly below 5 mg KOH/g.

In one embodiment, the fatty acid esters for use in accordance with the invention have iodine numbers of between 0 and 150 (measured in accordance with DIN 53241).

In one preferred embodiment, the fatty acid esters used are esters whose varnish viscosity is situated in the range from 1000 to 4000 mPas, preferably 1500 to 3000 mPas. By varnish viscosity here is meant the viscosity possessed by one comprising 20 parts by weight of the (industry standard) solid resin Setalin P 7000 (compare the example section) and 80 parts by weight of the fatty acid ester serving as solvent, at 23° C. (measurement of the viscosity by means of a Bohlin rotational viscometer with a shear rate of 50 s⁻¹).

In another preferred embodiment, the fatty acid esters used are esters whose Kauri-butanol value is in the range from 25 to 70 and preferably in the range from 30 to 50. The Kauri-butanol value here is to be determined in accordance with ASTM D 1133, the respective solvent being titrated against a saturated solution of a Kauri resin (“Kauriharz” from Lamee, Göttingen) in n-butanol. The Kauri-butanol value should be determined at 23° C.

In another preferred embodiment, the fatty acid esters used are esters whose molar weight is situated preferably in the range from 600 to 1500.

Examples of suitable fatty acids which form a basis, as fatty acid building blocks, for the fatty acid esters of the invention are the saturated fatty acids hexanoic acid (caproic acid), heptanoic acid, octanoic acid (caprylic acid), nonanoic acid (pelargonic acid), decanoic acid (capric acid), undecanoic acid, dodecanoic acid (lauric acid), tridecanoic acid, tetradecanoic acid (myristic acid), pentadecanoic acid, hexadecanoic acid (palmitic acid), heptadecanoic acid, oxtadecanoic acid (stearic acid), nonadecanoic acid, eicosanoic acid (arachidic acid), dodecanoic acid (behenic acid), and the unsaturated fatty acids 10-undecenoic acid, lauroleic acid, myristoleic acid, palmitoleic acid, petroselinic acid, oleic acid, elaidic acid, linoleic acid, linolenic acid, eleostearic acid, gadoleic acid, arachidonic acid, erucic acid, and brassidic acid. It is preferred to use fatty acids of natural origin.

In one embodiment, the fatty acids which form the basis, as fatty acid building blocks, for the fatty acid esters of the invention have 8 to 18 C atoms.

In one embodiment, the polyhydroxy compounds which serve as a basis, as building blocks, for the fatty acid esters of the invention are selected from the polyglycerols. By polyglycerols are meant, as is known, condensation products of glycerol. The simplest polyglycerol, which comes about through condensation of 2 molecules of glycerol, is diglycerol, which is then followed, in the manner of a homologous series, by triglycerol, tetraglycerol, and so on. It is preferred to select the polyhydroxy compound building block of the fatty acid esters from the group diglycerol, triglycerol, and tetraglycerol; in this context, diglycerol and triglycerol are particularly preferred as polyglycerols. In one particularly preferred embodiment, the fatty acid ester for use in accordance with the invention is diglycerol tetracaprylate.

In one embodiment, the polyhydroxy compounds serving, as a basis, as building blocks, for the fatty acid esters of the invention are selected from the adducts of 1 to 20 mol of ethylene oxide and/or propylene oxide with polyglycerols. The polyglycerols here are defined as described above. Adducts of 1 to 20 mol of ethylene oxide and/or propylene oxide with diglycerol and triglycerol are particularly preferred in this context.

Additionally provided by the invention are offset printing inks which comprise one or more resins and one or more solvents, these solvents for the resin or resins being fatty acid esters based on C₆₋₂₆ fatty acids and polyhydroxy compounds which are selected from the group consisting of polyglycerols and adducts of 1 to 20 mol of ethylene oxide and/or propylene oxide with polyglycerols.

In one preferred embodiment, the resins used are resins of the kind which are customary in the offset printing inks sector.

In one specific embodiment, the offset printing inks comprise a rosin-modified phenolic resin (A) and/or a maleate resin (B) and/or a modified hydrocarbon resin (C) and/or a rosin ester (D) and, as solvents for the resin or resins, one or more fatty acid esters based on C₆₋₂₆ fatty acids and polyhydroxy compounds which are selected from the group consisting of polyglycerols and adducts of 1 to 20 mol of ethylene oxide and/or propylene oxide with polyglycerols.

In one preferred embodiment, the offset printing inks of the invention are completely free of mineral oil.

Beyond the obligatory constituents formed by resin(s), solvent(s), and chromophore(s), the offset printing inks of the invention may also comprise further constituents, more particularly those which are very familiar to the skilled person in this field. It is expressly noted that chromophores, more particularly pigments, are of course an obligatory constituent of offset printing inks.

The offset printing inks of the invention are preferably free from substances with a high migration potential. The resins and fatty acid esters for use in accordance with the invention that are present in the binders of the inks are harmonized with one another such that the physical transition, including in the case of primary packaging on foods, is reduced in such a way that the values fall significantly below the limiting values prescribed by statute. Moreover, in the event of direct contact between the printed ink and, for example, a polypropylene packaging film, as a result of virtually complete absence of a physical transition, there is virtually no change in dimensions, in other words no migration into the polymeric matrix (i.e., no film swelling).

The offset printing inks of the invention can be identified as low-odor, low-migration, and low-swelling inks, and are therefore suitable in particular for the production of food packaging using, for example, card and paper.

### EXAMPLES

### Substances Used

| | |
|---|---|
| Setalin P 7000 | Rosin (from Akzo Nobel |
| | Resins) |
| Diglycerol TGI-caprylate | Full ester of a mixture of |
| | 33% mono-, 33% di-, 19% |
| | tri-, and 15% tetraglycerol |
| | and caprylic acid (from |
| | Cognis Deutschland GmbH) |
| Diglycerol tetracaprylate | Glycerol ester based on |
| | substantially diglycerol and |
| | caprylic acid (from Cognis |
| | Deutschland GmbH) |
| Texaprint SPOC | Pentaerythritol tetraoctoate |

### Production of the Formulas

### General

Of key importance for the production of offset printing ink formulas are the solvents. Here, the solvency of the solvents is an essential parameter. This solvency was determined by determination of the Kauri-butanol value, which is known to the skilled person. This test method is indicated in more detail under “Test methods used”.

A further parameter for the definition of the solvency of fatty acid esters is the solution viscosity of varnishes (solutions of solid resins in the solvents). The test method used for this is indicated in more detail under “Test methods used”.

### The Formulas

The varnishes were produced as follows: 20 parts by weight of the solid resin Setalin P 7000 were admixed with 80 parts by weight of each of the solvents to be investigated, and the mixture was heated with stirring to 180-200° C. This gave a solution of the solid resin in the respective solvent. This solution, in accordance with the custom usual in the art, is referred to as a varnish.

The varnishes were characterized through determination of their viscosity. The test method used for this purpose is indicated in more detail under “Test methods used”.

The tables for examples B1, B2, and C1 (comparative example) show the composition of the varnishes (% by weight of the individual constituents, based on the varnish as a whole):

### Test Methods Used

### 1) Solvency

The value known as the Kauri-butanol value is frequently employed by experts in order to determine the solvency for printing ink resins. The Kauri-butanol value here characterizes the solvency of the solvents. Accordingly, the solvency was determined by measurement of the Kauri-butanol value in accordance with ASTM D 1133. For the determination of the Kauri-butanol value, the respective solvent was titrated against the saturated solution of a Kauri resin (“Kauriharz” from Lamee, Göttingen) in n-butanol. The Kauri-butanol value was determined at 23° C.

### Typical Kauri-Butanol Values are as Follows:

| | |
|---|---|
| aromatics-free mineral oils | about 20 |
| aromatics-rich mineral oils | about 40-50 |
| toluene | about 105-110 |

### 2) Solution Viscosity

The viscosity was determined in accordance with the Eurocommit method, which is known to the skilled person. For this purpose, 20 parts by weight of the resin Setalin P 7000 were mixed with 80 parts by weight of the respective solvent component, and the resin was dissolved by heating at 180-200° C. with stirring. The solution (solutions of this kind are referred to by the skilled worker as varnishes) was then cooled to 23° C. Thereafter the viscosities of the individual varnishes were determined with the aid of a Bohlin rotational viscometer. These values were measured with a shear rate of 50 s⁻¹ at 23° C.

### Example Formulas

### Example 1

### Comparative Example (C1)

The varnish was produced as described above.

Composition of the varnish

| Varnish | |
|---|---|
| Setalin P 7000 | 20 |
| Pentaerythritol tetraoctoate | 80 |

Measurement Data (in Accordance with the Test Methods Described Above):
Viscosity of pentaerythritol tetraoctoate: 41 mPas
Molar weight of pentaerythritol tetraoctoate: 641
Solvency of pentaerythritol tetraoctoate (Kauri-butanol value): 40
Varnish viscosity: 1280 mPas

### Example 2

### Inventive Example (B1)

The varnish was produced as described above.

Composition of the varnish

| Varnish | |
|---|---|
| Setalin P 7000 | 20 |
| Diglycerol TGI caprylate | 80 |

Measurement Data (in Accordance with the Test Methods Described Above):
Viscosity of diglycerol TGI caprylate: 79 mPas
Average molar weight of diglycerol TGI caprylate: 720
Solvency of diglycerol TGI caprylate (Kauri-butanol value): 38
Varnish viscosity: 1600 mPas

### Example 3

### Inventive Example (B2)

The varnish was produced as described above.

Composition of the varnish

| Varnish | |
|---|---|
| Setalin P 7000 | 20 |
| Diglycerol tetracaprylate | 80 |

Measurement Data (in Accordance with the Test Methods Described Above):
Viscosity of diglycerol tetracaprylate: about 60 mPas
Molar weight of diglycerol tetracaprylate: about 690
Solvency of diglycerol tetracaprylate (Kauri-butanol value): 44
Varnish viscosity: 1750 mPas

### Overview of the Measurement Data

For better viewing, the measurement data already reported above are compiled once again in table form below:

### Solution Viscosities of the Varnishes

| See example | Varnish based on the solvent | Viscosity |
|---|---|---|
| C1 | Pentaerythritol tetraoctoate | 1280 mPas |
| B1 | Diglycerol TGI caprylate | 1600 mPas |
| B2 | Diglycerol tetracaprylate | 1750 mPas |

### Solvency of the Solvents

| Solvent | Kauri-butanol value |
|---|---|
| Pentaerythritol tetraoctoate | 40 |
| Diglycerol TGI caprylate | 38 |
| Diglycerol tetracaprylate | 44 |

1. A solvent for offset printing inks comprising at least one fatty acid ester that is the reaction product of at least one C₆₋₂₆ fatty acid and at least one polyhydroxy compound selected from the group consisting of polyglycerols and adducts of 1 to 20 mol of ethylene oxide and/or propylene oxide with polyglycerols.

2. The solvent of claim 1, wherein the fatty acid ester is a full ester.

3. The solvent of claim 1 wherein the fatty acid ester is derived from at least one natural fatty acid having 8 to 18 carbon atoms.

4. The solvent of claim 1 wherein the fatty acid ester is derived from at least one polyhydroxy building block selected from the group consisting of diglycerol, triglycerol, and tetraglycerol.

5. The solvent of claim 1 wherein the fatty acid ester is derived from at least one polyhydroxy building block selected from the group consisting of diglycerol and triglycerol.

6. The solvent of claim 1, wherein the fatty acid ester is diglycerol tetracaprylate.

7. An offset printing ink comprising one or more resins and one or more solvents, wherein the one or more solvents comprise at least one fatty acid ester that is the reaction product of at least one C₆₋₂₆ fatty acid and at least one polyhydroxy compound selected from the group consisting of polyglycerols and adducts of 1 to 20 mol of ethylene oxide and/or propylene oxide with polyglycerols.

8. The offset printing ink of claim 7, wherein the one or more resins comprise a rosin-modified phenolic resin (A), a maleate resin (B), a modified hydrocarbon resin (C), a rosin ester (D), or combinations thereof.

9. The offset printing ink of claim 7, wherein the fatty acid ester is a full ester.

10. The offset printing ink of claim 7 having a Kauri-butanol value in the range of 40-50.

11. The solvent of claim 1 having a solution viscosity in accordance with the Eurocommit method in the range of 1600 to 1750 mPas when 80 parts of the solvent are mixed with 20 parts of a resin.

12. A method of producing solvents for offset printing inks comprising using a fatty acid ester that is the reaction product of at least one C₆₋₂₆ fatty acids and at least one polyhydroxy compound selected from the group consisting of polyglycerols and adducts of 1 to 20 mol of ethylene oxide and/or propylene oxide with polyglycerols for producing solvents for offset printing inks.

13. The method of claim 12, wherein the fatty acid ester is a full ester.

14. The method of claim 12, wherein the fatty acid ester is derived from at least one natural fatty acid having 8 to 18 carbon atoms.

15. The method of claim 12, wherein the fatty acid ester is derived from at least one polyhydroxy building block selected from the group consisting of diglycerol, triglycerol, and tetraglycerol.

16. The method of claim 12, wherein the fatty acid ester is derived from at least one polyhydroxy building block selected from the group consisting of diglycerol and triglycerol.

17. The method of claim 12, wherein the fatty acid ester is diglycerol tetracaprylate.
